(19) United States
(12) Patent Application Publication
(10) Pub. No.: US 2024/0001468 A1
(43) Pub. Date: Jan. 4, 2024

(54) Nozzle

(71) Applicant: Texture Jet Limited, Nottingham Nottinghamshire (GB)

(72) Inventors: Jonathon MITCHELL-SMITH, Nottingham, Nottinghamshire (GB); Simon TAYLOR, Nottingham, Nottinghamshire (GB); Jack FOSTER, Nottingham, Nottinghamshire (GB); Patrick BOINTON, Nottingham, Nottinghamshire (GB)

(21) Appl. No.: 18/255,636

(22) PCT Filed: Dec. 6, 2021
(86) PCT No.: PCT/GB2021/053178

§ 371 Date: Jun. 2, 2023

(30) Foreign Application Priority Data
Dec. 4, 2020 (GB) 2019164.9

(51) Int. Cl. B23H 9/16; B23H 3/10; B23H 3/04

(52) U.S. Cl. CPC B23H 9/16; B23H 3/10; B23H 3/04

(57) ABSTRACT

A nozzle for an electrochemical machining device. The nozzle defining a body with first and second releasably attachable body portions forming an electrolyte cavity therebetween, when the first and second body portions are attached. The body includes an inlet port upstream of the cavity, and an outlet port for dispensing a jet of electrolyte towards a surface of a workpiece, in use, where a flow path is defined from the inlet port through the cavity to the outlet port.

### CROSS-REFERENCE TO RELATED APPLICATIONS

The application is a US national phase of International Patent Application No. PCT/GB2021/053178, filed Dec. 6, 2021, which, in turn, claims the right of priority to GB Patent Application No. 2019164.9, filed Dec. 4, 2020, the disclosures of both of which are hereby incorporated by reference herein in their entirety for all purposes.

### FIELD

The present teachings relate to a nozzle for an electrochemical machining device, and to an electrochemical machining device.

### BACKGROUND

Electrochemical machining is a known process for selectively machining a surface of a workpiece. This machining method enables surfaces to be machined via an electrochemical reaction as long as the surface material is conductive. Through electrochemical machining, surfaces can be roughened to improve bonding for mounting components and/or applying coatings to the surface. Surface machining can also be used for modifying the optical and/or tribological properties of the surface, revealing the grain boundaries of the microstructure of the surface, or polishing the surface to produce a homogenous surface finish.

Electrochemical jet processing is a form of electrochemical machining involving applying a voltage between a part, e.g. a nozzle, of an electrochemical machining device and the surface to be machined, whilst dispensing a stream or jet of electrolyte from the nozzle towards the surface. The electrolytic current between the anodic surface and the cathodic nozzle is supplied via the electrolyte jet ejected from the nozzle. The design of the nozzle effects both the flow properties of the electrolyte jet and also the current density distribution across the jet. Manufacturing of known nozzles to produce the desired flow properties and current density distribution can be difficult due to the complex nature of the nozzle design.

The present teachings seek to overcome or at least mitigate one or more problems associated with the prior art.

### SUMMARY

A first aspect of the teachings provides a nozzle for an electrochemical machining device, the nozzle defining a body comprising: an internal cavity for receiving an electrolyte therein; an inlet port upstream of the cavity and in fluid communication therewith for delivering an electrolyte into the cavity; and an outlet port for dispensing a jet of electrolyte towards a surface of a workpiece, in use, wherein the outlet port is downstream of the cavity and in fluid communication therewith so as to define a flow path from the inlet port through the cavity to the outlet port, and wherein the body comprises first and second releasably attachable body portions forming the cavity therebetween, when the first and second body portions are attached.

Forming the body of the nozzle from two releasably attachable portions facilitates manufacture of the nozzle. Through this arrangement, the internal nozzle configuration is able to be precisely machined so as to provide the required flow properties of the electrolyte jet.

The first and second body portions may be configured and arranged to form a seal therebetween surrounding the cavity, when the first and second body portions are attached.

Providing a seal surrounding the cavity helps to reduce leakage, which works to ensure that all of the electrolyte is directed to the outlet port.

This arrangement of seal automatically forms the seal between the first and second body portions when they are attached.

The first and second body portions may comprise first and second seal formations.

The first and second seal formations may comprise a projection on the first or second body portion and a corresponding recess on the other of the first or second body portion.

A sealant may be provided in the recess.

The sealant provided may only partially fill the recess.

The sealant may comprise a polyurethane sealant or a silicone sealant.

Providing the first and second seal formations in the form of a recess and corresponding projection works to provide an alignment feature to facilitate assembly the first and second body portions.

The first and second body portions may be configured and arranged to form a labyrinth seal therebetween.

A combination of seal elements (i.e. the projection and the recess) forms a strong seal within the body, as the electrolyte is limited from escaping by the tortuous exit path they must take.

The first and second body portions may define first and second opposing cavity walls.

The first and second opposing cavity walls may taper in a direction towards the outlet port.

Advantageously, this arrangement helps to direct the flow of electrolyte towards the outlet port so as to provide a more laminar flow.

The first and second cavity walls may taper to a minimum separation at a position spaced apart from the outlet port. The first and second cavity walls may taper to a minimum separation to define a throat portion at a position spaced apart from the outlet port.

The decrease in separation between the opposing walls of the cavity helps to increase the velocity of the electrolyte flowing towards the outlet port.

The first and second opposing cavity walls may diverge in a direction between the throat portion and the outlet port such that the separation between the first and second opposing cavity walls increases.

This downstream divergent end has been found to have a stabilising effect on the flow of electrolyte.

Additionally, having the minimum separation between the opposing walls of the cavity spaced apart from the outlet port helps to prevent surface tension of the electrolyte causing the electrolyte to block the outlet port.

The first and second opposing cavity walls may each comprise lateral wall portions that define cavity side walk, when the first and second body portions are attached.

The cavity side walls may taper in a direction towards the outlet port.

The cavity side walls may taper from a maximum separation proximate the inlet port.

The cavity side walls may taper to a minimum separation proximate the outlet port.

An outlet region of the cavity side walls proximate the outlet port may be curved inwardly.

The outlet region comprising the inwardly curved side walls may be immediately upstream, e.g. immediately above, the outlet port.

This increases the resistance to the electrolyte jet stream at the lateral edges of the outlet port. This in turn helps to equalise the machining effects across the width of the electrolyte jet, which otherwise would have a higher machine rate in these side regions.

The body may comprise an end surface substantially surrounding the outlet port and intended to be arranged to oppose a surface of a workpiece, in use. The end surface may define a substantially planar region surrounding the outlet port.

The substantially planar region may be intended to oppose a surface of a workpiece, in use.

The area facing the surface is designed to provide a specific area designed to optimise the interaction of electrical potential seen by the surface in this case to provide an even application of machining action across the width of the surface.

The body may comprise an end surface substantially surrounding the outlet port and intended to be arranged to oppose a surface of a workpiece, in use. The end surface may be substantially non-planar.

The end surface may comprise lateral regions that are at least partially curved or tapered towards an inner region of the end surface.

This is to aid equalisation of machining effects across the nozzle width where without this a higher rate of machining occurs at the edge of the jet due to flow effects and concentration of charge. This modification helps negate the effects effectively increasing resistance in the jet stream at the outer edge and reducing machinery efficiency and so equalling out the effect across the entire width of the jet.

The inner region may be curved such that the end surface defines a continuously curved surface.

The inner region may be substantially planar.

The inner region may be curved or angled such that the inner region forms a recessed region of the end surface.

The end surface of the nozzle may be triangular, trapezoidal, semi-circular, hexagonal, oval or elliptical in side view or in cross-section.

The end surface of the nozzle may be an undulating surface.

The body may comprise an outlet spout surrounding the outlet port.

An external region of the body adjacent to the outlet spout, e.g. above the outlet spout, may be tapered or chamfered.

The first and second body portions may comprise first and second external surfaces.

The first and second external surfaces may define a tapered or chamfered region intended to be positioned above, i.e. immediately above, the outlet port, i.e. outlet spout, in use.

This lowermost chamfered region deflects any impacting liquid away from the electrolyte jet. Thus, this chamfered region is provided to minimise any splashback from jetted fluid bouncing back from the workpiece surface and causing secondary machining effects by rebounding off the nozzle back onto the surface.

The nozzle may comprise an attachment arrangement configured to releasably attach the first and second body portions.

The attachment arrangement may comprise at least one bore in each of the first and second body portions for receiving a fastener therethrough.

The attachment arrangement may form a mounting arrangement for mounting the nozzle to an electrochemical machining device.

The outlet port may be defined by a spacing between the first and second body portions.

The outlet port may be provided on a surface of the body intended to be lowermost in use.

The body may be formed from a conductive material.

The body may comprise a metal or metal alloy, for example steel.

The outlet port may comprise a width in the range 1 mm to 25 mm. The outlet port may comprise a width in the range 5 mm to 20 mm. The width may be approximately 10 mm.

The outlet port may comprise a depth in the range 0.01 mm to 1 mm. The outlet port may comprise a depth in the range 0.05 mm to 0.5 mm. The depth may be approximately 0.2 mm.

The outlet port may be substantially rectangular.

A second aspect of the teachings provides an electrochemical machining device for machining a surface of a workpiece, the electrochemical machining device comprising: an electrolyte source; and a nozzle according to the first aspect configured and arranged to receive electrolyte from the electrolyte source via the input port and to dispense an electrolyte jet from the outlet port towards a surface of a workpiece, in use.

The electrochemical machining device may be configured to apply a charge to the nozzle and to apply a charge to a surface of a workpiece such that the nozzle and said surface define first and second electrodes of an electrolytic cell, in use.

The nozzle may be arranged so as to be spaced apart from a surface of a workpiece, in use.

The electrochemical device may comprise a contact electrode configured and arranged to contact a surface of a workpiece, in use, and to apply a current thereto.

The electrochemical machining device may comprise a second nozzle according to the first aspect.

The electrochemical machining device may comprise a second electrolyte source.

Each of the two nozzles may be configured for dispensing a different electrolyte.

### BRIEF DESCRIPTION OF THE DRAWINGS

Embodiments will now be described with reference to the accompanying drawings, in which:

FIG. 1 is a schematic view of an electrochemical machining device according to an embodiment;

FIG. 2 shows a machining unit of the electrochemical machining device of FIG. 1, where the machining unit is operated by a robotic arm;

FIG. 3 is an isometric view of a nozzle of the electrochemical machining device of FIG. 1;

FIG. 4 is a partially cutaway isometric view of the nozzle of FIG. 3;

FIG. 5 is a side view of the nozzle of FIG. 3;

FIG. 6 is a cross-sectional side view of the nozzle of FIG. 3; and

FIGS. 7A and 7B are front views of first and second body portions of the nozzle of FIG. 3, respectively.

FIG. 8 is a front view of the body of the nozzle of FIG. 3;

FIGS. 9A, 9B and 9C are front views of first body portions of a nozzle according to embodiments.

### DETAILED DESCRIPTION OF EMBODIMENT(S)

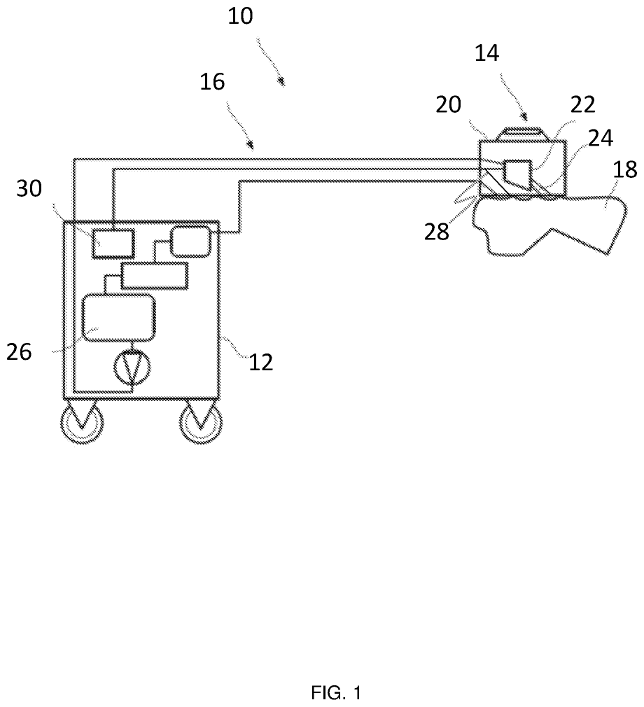

Referring firstly to FIG. 1, an electrochemical machining device is illustrated and is indicated generally at 10. The electrochemical machining device 10 includes a base unit 12 and a machining unit 14. It will be appreciated that the machining unit 12 may be intended to be hand-held, may be operated by a robotic arm, or may be intended to be operated remotely to be driven over a surface.

The base unit 12 and machining unit 14 are connected via an umbilical cord 16 through which the base unit 12 is able to supply power and electrolyte to the machining unit 14. Connection of the machining unit 14 to the base unit 12 via the flexible umbilical cord 16 enables the machining unit 14 to be moved independently of the base unit 12. Put another way, the machining unit 14 is provided as a portable unit. This arrangement enables the device 10 to be to be moved into contact with a surface 18 of a workpiece, i.e. to be used in-situ either as part of a mobile device or as part of a fixed position machining system.

In alternative arrangements, the machining unit 14 may be substantially fixed in place. In such arrangements, the electrochemical machining device 10 may not include the separate base unit 12 and machining unit 14 and may be provided as a standalone unit that is fixed in place and where the workpiece is positioned under a machining unit so as to be machined.

The electrochemical machining device 10 includes a nozzle 22. The nozzle 22 may be provided in the machining unit 14. In the illustrated arrangement, the nozzle 22 is provided in housing 20 of the machining unit 14. The nozzle 22 is configured to dispense an electrolyte jet 24 towards a surface 18 of a workpiece.

The housing 20 is configured to define an enclosed workspace when positioned against a surface 18 of a workpiece. It will be appreciated that the nozzle 22 may be removably mounted within the housing 20 to allow for different nozzles to be used for different machining operations. In some alternative arrangements, the housing 20 may not be provided.

The electrochemical machining device 10 includes an electrolyte source 26 for supplying electrolyte to the nozzle 22. In the illustrated arrangement, the electrolyte source is an electrolyte reservoir 26. The electrolyte reservoir 26 may be provided in the base unit 14. The nozzle 22 is configured and arranged to receive electrolyte from the electrolyte source 26 via an inlet and to dispense an electrolyte jet 24 from an outlet towards a surface of a workpiece, in use.

The electrolyte may be a water-based electrolyte. The electrolyte may be provided as a water-salt solution, for example a water based solution comprising one or more of sodium nitrate, sodium chloride, sodium iodide etc. It will be appreciated that any suitable electrolyte may be used, such as a substantially water free ionic solvent.

The electrochemical machining device 10 is configured to apply a charge to the nozzle 22 and the surface 18. In this way, the nozzle 22 and the surface 18 form first and second electrodes of an electrolytic cell.

The nozzle 22 may be conductive. Put another way, the nozzle 22 may be formed a conductive material. The nozzle 22 may be formed from a metal or metal alloy, for example steel. In alternative arrangements, the electrochemical machining device 10 may include an additional electrode, separate from the nozzle 22, and the electrochemical machining device 10 may be configured to apply a charge to the additional electrode and the surface 18. In such alternative arrangements, the nozzle 22 may be formed from any suitable material.

The electrochemical machining device 10 includes a contact electrode 28 configured and arranged to contact at least a portion of the surface 18, in use. Through this contact electrode 28, the electrochemical machining device 10 is able to apply to charge to the surface 18. In this way, the surface 18 and the nozzle 22 are able to form an electrolytic cell, to enable the electrochemical machining to occur.

The nozzle 22 is arranged on the electrochemical machining device 10 (e.g. within the housing 20) so as to be spaced apart from the surface 18, in use. The spacing between the electrode 22 and the workpiece surface 18 (i.e. the inter-electrode gap) affects the processing of the surface 18. The nozzle 22 is moveable relative to the surface 18 so as to move over the surface 18 and/or to adjust the spacing between the nozzle 22 and the surface 18.

In order to be able to apply a charge to the nozzle 22 and the surface 18 (i.e. via the contact electrode 28), the electrochemical machining device 10 includes a power source 30. It will be appreciated that in order to supply power to the electrochemical machining device 10, the power source 30 may include one or more batteries or may be connectable to an external power source.

Material removal and deposition is achieved by an electrolyte being supplied through the nozzle 22 and jetted towards the surface 18. An electrical potential is applied between the nozzle 22 and the surface 18 resulting in either anodic dissolution of the surface 18, or deposition onto the surface 18. In a first mode of operation, a negative charge is applied to the nozzle 22 and a positive charge is applied to the surface 18. In this first mode of operation, the device 10 etches away at the surface 18 so as to modify the topography thereof. In a second mode of operation, a positive charge is applied to the nozzle 22 and a negative charge is applied to the surface 18. In this second mode of operation, material (e.g. such as silica particles or additive coatings to allow functionalisation of the surface) are able to be deposited onto the surface 18, which modifies the surface topography thereof.

Although not illustrated, in alternative arrangements the electrochemical machining device 10 may include a second nozzle 22 for dispensing an electrolyte jet 24 towards a surface 18 to be machined. This allows a greater degree of control of the surface topography created and optimised cycle times due to exploitation of the dual electrolyte jets. In such arrangements, both the first and second nozzles 22 may be configured to dispense the same electrolyte. Alternatively, the electrochemical machining device 10 may include a second electrolyte source, and the two nozzles 22 may be configured for dispensing different electrolytes.

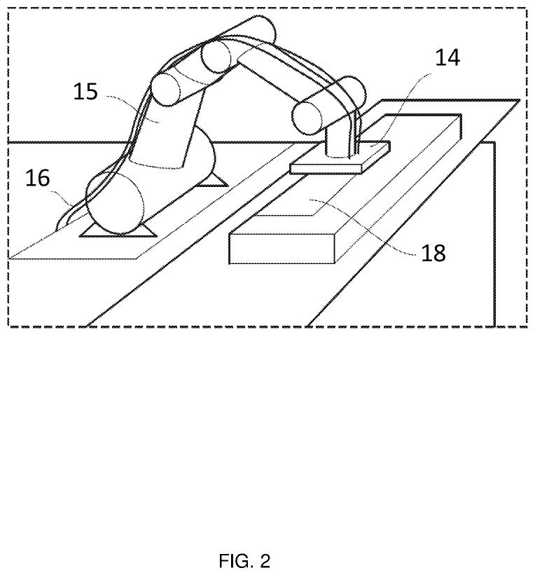

Referring to FIG. 2, the machining unit 14 is moveable with respect to the base unit (not shown) and is operated by a robotic arm 15. The machining unit 14 is connected to the base unit via the umbilical cord 16. It will be appreciated that the robotic arm 15 relay be provided as a part of an automated production line.

The machining unit 14 of FIG. 2 is configured such that it is able to be moved over a surface 18 of a workpiece by robotic arm 15 without having to remove and the re-attach said machining unit. This arrangement enables machining to be carried out continuously over the surface 18. Although not illustrated, the machining unit 14 may include one or more contact points arranged to engage the surface 18 and be moveable/slideable thereover.

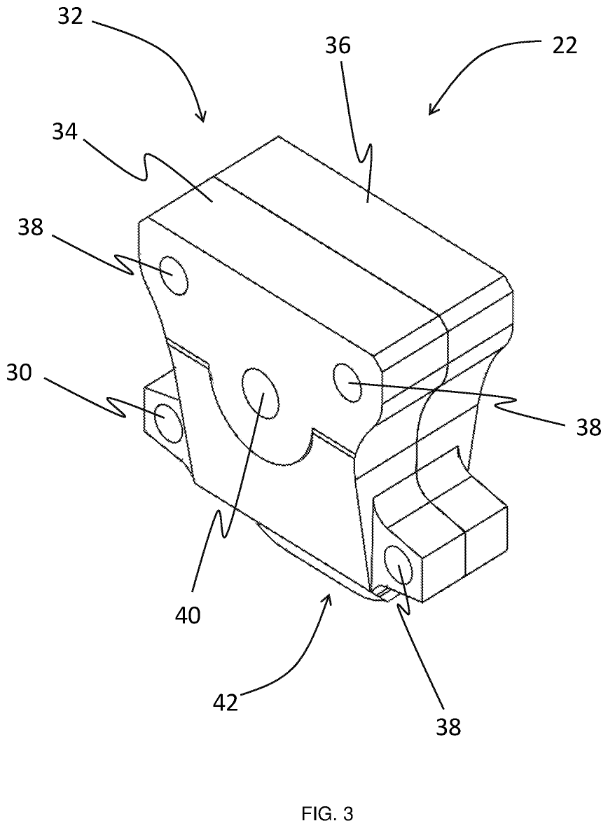

Referring now to FIG. 3, the nozzle 22 for an electrochemical machining device is illustrated in more detail.

The nozzle 22 is configured to dispense an electrolyte jet 24 towards a surface 18 of a workpiece. The nozzle 22 includes a body 32, The body 32 of the nozzle 22 is formed from first 34 and second 36 releasably attachable body portions. The first and second body portions 34, 36 are provided with complementary surface formations to as to enable their assembly.

The nozzle 22 is provided with an attachment arrangement 33 for releasably attaching the first and second body portions 34, 36. The attachment arrangement 38 is provided in the form of one or more bores extending through each of the first and second body portions 34, 36. A corresponding number of bores 44 is provided on each of the first and second body portions 34, 36. The aperture(s) of the first and second body portions 34, 36 align so as to be capable of receiving a fastener (not shown) therethrough to attach the first and second body portions 34, 36. In the illustrated embodiment, the attachment arrangement 38 includes four bores on each of the first and second body portions 34, 36.

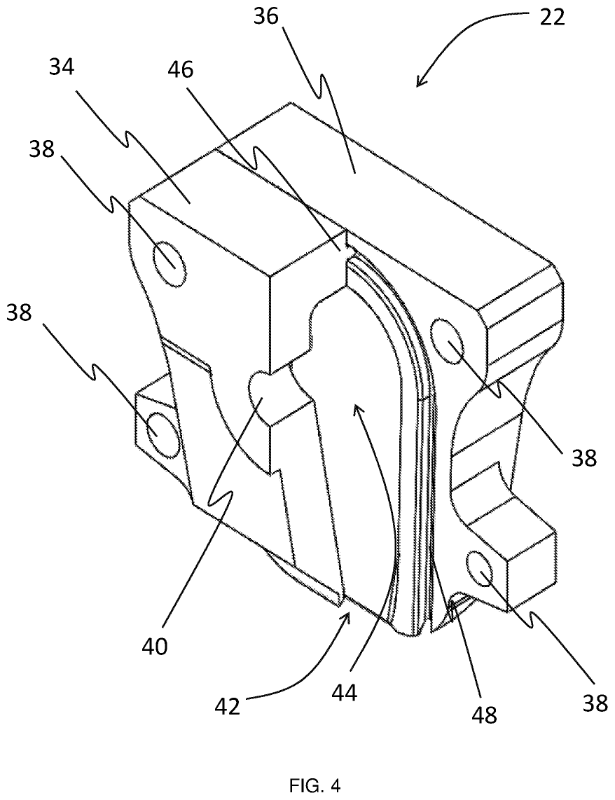

Referring now to FIG. 4, the nozzle 22 includes an inlet port 40 and an outlet port 42. In the illustrated arrangement, the inlet port 40 is provided on the first body portion 34. The outlet port 42 is defined by a spacing between the first and second body portions 34, 36. The outlet port 42 is provided on a surface of the body 32 of the nozzle 22 that is intended to be lowermost in use.

The outlet port 42 provides an opening through which electrolyte can be jetted towards the surface 18 of the workpiece. In the illustrated embodiment, the outlet port 42 is substantially rectangular. The outlet port 42 defines a width and a depth. The nozzle aperture size (i.e. width and depth) is governed by the ability of the electrical power supply to create sufficient current density on the surface 18 of the workpiece.

The width of the outlet port 42 may be in the range 1 mm to 25 mm, for example in the range 5 mm to 20 mm. In one arrangement, the width of the outlet port 42 may be approximately 10 mm. The depth of the outlet port 42 may be in the range 0.01 mm to 1 mm, for example in the range 0.05 mm to 0.5 mm. In one arrangement, the depth of the outlet port 42 may be approximately 0.2 mm.

The body 32 includes an internal cavity 44 for receiving an electrolyte therein. When the first and second body portions 34, 36 are attached (i.e. when they are in an assembled state), the cavity 44 is formed therebetween. The cavity 44 is formed by opposing recessed regions on the first and second body portions 34, 36.

The inlet port 40 is arranged so as to be upstream of the cavity 44 and in fluid communication therewith such that electrolyte flows through the inlet port 40 and into the cavity 44 so as to deliver the electrolyte into the cavity 44.

The outlet port 42 is arranged so as to be downstream of the cavity 44 in fluid communication therewith such that electrolyte flows from the cavity 44 to the outlet port 42. In this way, the inlet port 40, cavity 44 and outlet port 42 define an electrolyte flow path through the nozzle 22 (i.e. from the inlet port 40 through the cavity 44 to the outlet port 42). The outlet port 42 is provided so as to enable the nozzle 22 to dispense a jet of electrolyte towards a surface 18 of a workpiece, in use.

The first and second body portions 34, 36 are configured and arranged to form a seal therebetween. The seal is arranged so as to substantially surround the cavity 44. In the illustrated embodiment, the seal is substantially U-shaped.

In order to form the seal, the first and second body portions 34, 36 include corresponding seal formations. A first seal formation 46 is provided on the first body portion 34. A second seal formation 48 is provided on the second body portion 36. The first and second seal formations 46, 48 are arranged such that they inter-engage when the first and second body portions 34, 36 are assembled.

The combination of seal formations 46, 48 forms a strong seal within the body 32 of the nozzle 22 so as to prevent/minimise leakage of electrolyte. The inter-engaging of the first and second seal formations 46, 48 may form a labyrinth seal therebetween. In this way, the electrolyte is limited from leaking by the tortuous exit path it must take.

The first seal formation 46 is provided in the form of a projection 46. The second seal formation 48 is provided in the form of a recess 48 configured to receive the projection 46. In alternative arrangements, it will be appreciated that the first body portion 34 may be provided with a recessed seal formation, and the second body portion may be provided with a projection seal formation. Providing the first and second seal formations in the form of a recess 46 and a corresponding projection 48 enables the seal formations to provide an alignment arrangement to facilitate assembly the first and second body portions 34, 36.

In some arrangements, a sealant may be provided between the first and second seal formations 46, 48. The sealant may be held within the groove. It will be appreciated that the volume of sealant provided would be less than or equal to the volume of the groove. This helps to prevent the sealant creating a spacing between the first and second body portions 34, 36 (which would increase the size of the outlet port). The sealant may be a polyurethane sealant, a silicone sealant, or any other suitable type of sealant.

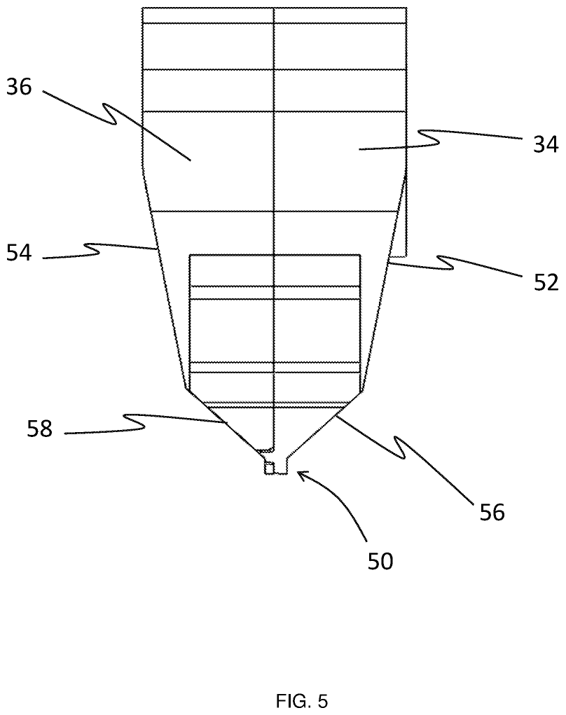

Referring now to FIG. 5, the external profile of the nozzle 22 is illustrated. The body 32 defines an end surface 50 surrounding the outlet port 42. In the arrangement shown, the end surface 50 is provided on an outlet spout. The end surface 50 is intended (i.e. is arranged within electrochemical machining device 10) to oppose a surface 18 of a workpiece, in use. The end surface 50 (i.e. the cross-sectional area of the end face 50 opposing the surface 18 provides a specific area designed to optimise the interaction of electrical potential seen by the surface 18. It will be appreciated that, in use, the angle of the end face 50 relative to the surface 18 may be adjusted. As will be discussed in more detail below, the end surface 50 is substantially non-planar, and the specific shape and configuration of the surface may be changed to suit the application.

Although not illustrated, the attachment arrangement 38 provides a mounting arrangement for mounting the nozzle 22 to the electrochemical machining device 10, e.g. to a mounting bracket (not shown) of the electrochemical machining device 10. However, in alternative arrangements, the mounting arrangement may be separate from the attachment arrangement 38.

The mounting arrangement is configured such that an external surface of the nozzle 22 abuts against a mounting bracket of the electrochemical machining device 10, in order to mount the nozzle 22 to the device 10. The electrochemical machining device 10 is configured such that the nozzle 22 is arranged at an angle (i.e. a non-perpendicular angle) to the surface 18. The angle of the nozzle 22 relative to the surface 18 of the workpiece may be in the range 0° to 60°, for example in the range 0° to 45°.

In one arrangement, the mounting bracket may be arranged at an angle (i.e. a non-perpendicular angle) to the surface 18 and the external surface of the nozzle 22 abutting against the mounting bracket may be substantially parallel to the mounting bracket. In this way, the angle of the nozzle 22 may be defined by the angle of the mounting bracket relative to the surface 18. In another arrangement, the mounting bracket may be substantially perpendicular to the surface 18, and the external surface of the nozzle 22 that abuts against the bracket may be angled relative to the mounting bracket. In this way, the angle of the nozzle 22 may be defined by the angle of the external surface of the nozzle 22 relative to the mounting bracket. In a further arrangement, the mounting bracket may be arranged at an angle (i.e. a non-perpendicular angle) to the surface 18 and the external surface of the nozzle 22 abutting against the mounting bracket may be angled relative to the mounting bracket. In this way, the angle of the nozzle 22 may be defined by a combination of the angle of the mounting bracket relative to the surface 18 and the angle of the external surface of the nozzle 22 relative to the mounting bracket.

The first and second body portions 34, 36 define opposing first and second external surfaces 52, 54 of the body 32 of the nozzle 22. The first and second external surfaces 52, 54 define a tapered or chamfered region. Put another way, the first and second external surfaces 52, 54 include first and second chamfered regions 56, 58.

The chamfered region is positioned above, e.g. immediately above, the end face or outlet spout 50, in use. This lowermost chamfered region deflects any liquid impacting this region away from the electrolyte jet. Thus, this chamfered region is provided to minimise any interference from jetted fluid bouncing back from the workpiece surface 18 and causing secondary machining effects by rebounding off the nozzle 22 and then back onto the surface 18.

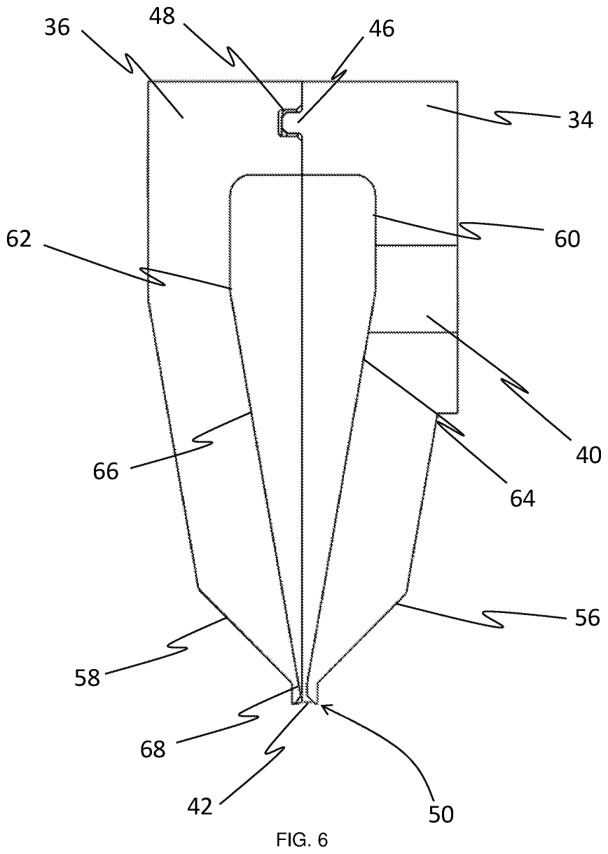

Referring to FIG. 6, the cavity 44 of the nozzle 22 is illustrated in more detail. As discussed above, the first and second body portions 34, 36 define the cavity 44, when they are assembled. The cavity 44 is defined by first and second recessed surfaces 60, 62 that define first and second opposing cavity walls 64, 66.

The first and second opposing cavity walls 64, 66 taper in a direction towards the outlet port 42. Put another way, the first and second cavity walls 64, 66 taper to a minimum separation to define a throat portion 68 at a position spaced apart from the outlet port 42.

The throat portion 68 is arranged to be spaced apart from the outlet port 42. The first and second opposing cavity walls 64, 66 diverge in a direction from the throat portion 68 to the outlet port 42. Put another way, the separation between the first and second opposing cavity walls 64, 66 increases in a direction from the throat portion 68 to the outlet port 42.

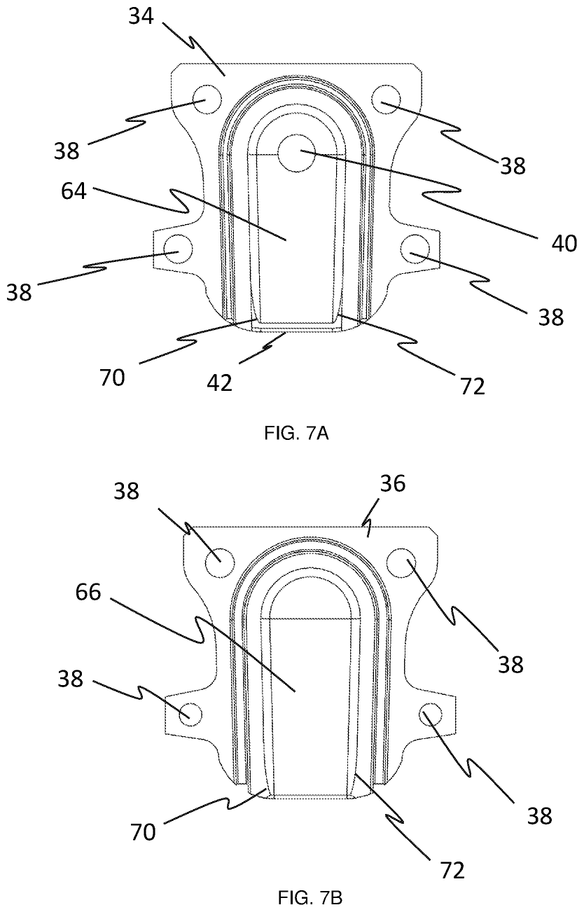

Referring now to FIGS. 7A and 7B, the first body portion 34 and the second body portion 36 of the of the nozzle 22 are illustrated, respectively. As discussed above, the cavity 44 is defined by first and second recessed surfaces 60, 62 that define first and second opposing cavity walls 64, 66. The first and second opposing cavity walls 64, 66 each comprise lateral wall portions 70, 72.

The lateral wall portions 70, 72 define side walls of the cavity 44, when the first and second body portions 34, 36 are attached. The side walls of the cavity 44, defined by the lateral wall portions 70, 72 taper in a direction towards the outlet port. Put another way, the lateral wall portions (i.e. the side walls) of the cavity 44 walls taper from a maximum separation proximate the inlet port 40. The side walls of the cavity 44 taper to a minimum separation proximate the outlet port 42.

A region, e.g. an outlet region, of the side walls of the cavity 44 proximate the outlet port 42 are curved inwardly. Put another way, a region, e.g. an outlet region, of the lateral wall portions 70, 72 proximate the outlet port 42 are curved inwardly.

The region or outlet region is arranged to be immediately upstream of the outlet port 42. Put another way, the region or outlet region is arranged so as to be immediately above the outlet port 42, in use. This arrangement of the inwardly curved opposing side walk increases the flow of electrolyte at the lateral edges of the jet. This in turn helps to equalise the machining effects across the width of the electrolyte jet, which otherwise would have a higher machine rate in these side regions.

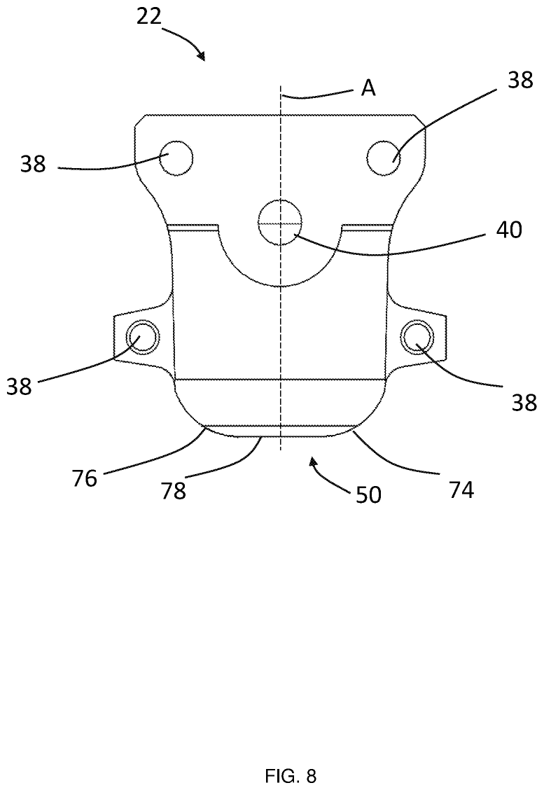

As discussed above, and shown in FIG. 8, the body 32 defines an end surface 50 that surrounds the outlet port 42. It will be appreciated that the end surface 50 is formed by distal, i.e. lower, edges of the first body portion 34 and the second body portion 36. The end surface 50 of the body 42 is substantially non-planar. The end surface 50 substantially symmetrical about the central axis A of the nozzle. In the arrangement shown, the end surface 50 defines a substantially curved or inwardly angled profile. Put another way, the end surface 50 defines lateral regions 74, 76 that are at least partially curved or tapered. This is to aid equalisation of machining effects across the nozzle width where without this a higher rate of machining occurs at the edge of the jet due to flow effects and concentration of charge. This modification helps negate these effects effectively increasing resistance in the jet stream at the outer edge and reducing machining efficiency and so equalling out the effect across the entire width of the jet. The lateral regions 74, 76 each define a continuously curved surface. In the arrangement shown, the lateral regions 74, 76 are convexly curved, but in alternative arrangements may be concavely curved, or may define any other suitable shape.

The end surface 50 (i.e. the lateral regions 74, 76) are curved or angled towards an inner region 78 of the end surface 50. In the arrangement shown, the inner region 78 is a substantially flat or planar surface. This configuration of the end surface 50 of the nozzle 22 is that it provides a current density profile that is lower at the edges (i.e. in the lateral regions 74, 76) and higher in the middle (i.e. across the inner region 78). This enables an even depth of removal of material to be obtained across the end surface 50 (i.e. across the machined channel)

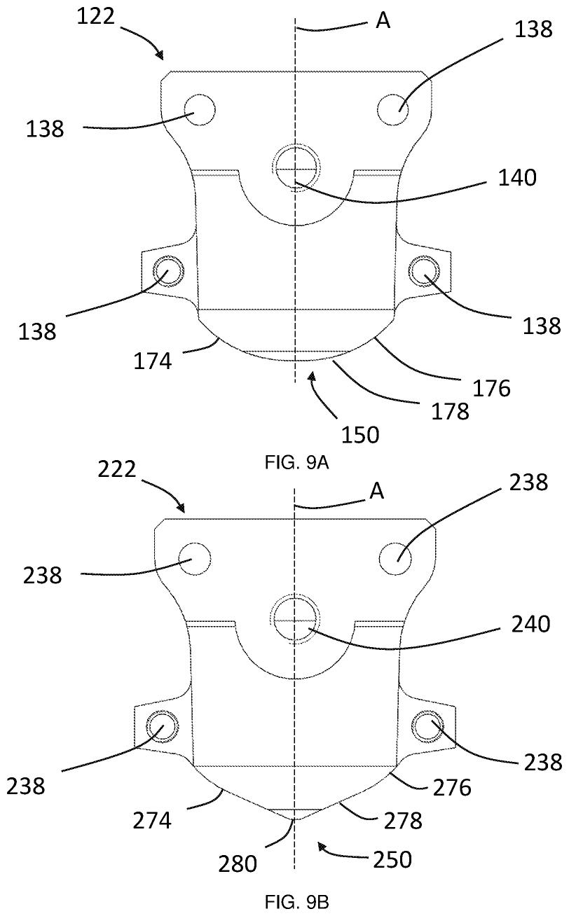

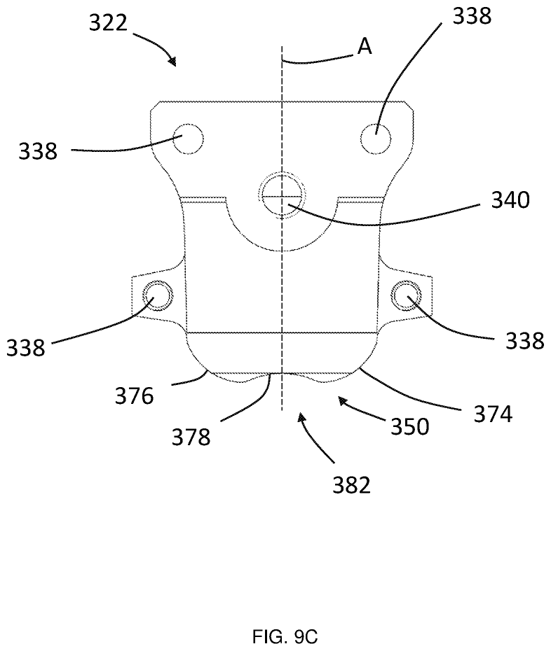

Referring now to FIGS. 9A, 9B and 9C, alternative configurations of the end face of the nozzle are illustrated. Only the differences between the nozzle 22 of FIGS. 3 to 8 will be described here, and similar reference features include a prefix ‘1’, ‘2’, and ‘3’, respectively.

In the arrangement of FIG. 9A, the inner region 178 is curved. The inner region 178 (e.g. the end surface 50) is substantially symmetrical about the central axis A of the nozzle. The curved profile is inwardly angled toward a central point of the nozzle 122. The inner region 178, in the arrangement shown, defines a convex curve, but it should be appreciated that the curve may be concave in alternative embodiments. The end surface 50 of the body 32 defines a continuously curved surface. In the illustrated arrangement, the curved end surface 50 comprises a substantially constant radius of curvature. This configuration will machine a curved profile on the surface that is deeper in the middle and shallower at the sides, which can be beneficial in creating increased surface area on a surface of a workpiece, for example for cooling/heating or creating channels for liquid retention. In alternative arrangements, the curvature of the inner region 178 may differ from that of the lateral regions 174, 176 such that the inner region 178 has either a greater or a lesser radius of curvature. In further alternative arrangements, the lateral regions 174, 176 may be curved as illustrated, but the inner region may be formed by a liner inclined/tapered surface. Although not illustrated, the end surface 150 of the nozzle 122 may comprise a substantially planar or flat central region (i.e. at or near the central axis A of the nozzle 122).

In the arrangement of FIG. 9B, the lateral regions 274, 276 are curved in a similar manner to what has been described above. In the illustrated embodiment, the lateral regions 274, 276 are convexly curved. The inner region 278 defines a straight, inwardly angled profile. Put another way, the inner region 278 is tapered (i.e. towards a central point of the end surface 250). The inner region 278 (e.g. the end surface 250) is substantially symmetrical about the central axis A of the nozzle 222. The end surface 250 of the nozzle 222 includes a substantially planar or flat central region 280. In this arrangement, the end surface 250 of nozzle 222 may be considered to be substantially trapezoidal in shape (i.e. in cross-section). This configuration will machine a substantially triangular profile on the surface that is deeper in the middle and shallower at the sides, which can be beneficial in creating increased surface area on a surface of workpiece, for example for cooling/heating or creating channels for liquid retention. The flat or planar region 280 is positioned to be at or near the central axis A of the nozzle 122, in the arrangement shown. Put another way, the end surface 250 defines a taper that extends from opposite sides of the nozzle 222. The opposite sides of the taper meet so as to define a central surface 280. The taper may be a uniform taper (i.e. a straight edge, or a curved edge). The taper may alternatively be non-uniform (i.e. including multiple regions that are differently angled or a combination of convex and concave curved regions).

In the arrangement of FIG. 9C, the end surface 350 of the nozzle 322 includes curved lateral regions 374, 376 as has been discussed with reference to FIGS. 8 and 9A. The substantially curved profile is inwardly angled toward a central point of the nozzle 322 (i.e. angled toward the central axis A of the nozzle 322). In this arrangement, the end surface 350 of the nozzle 322 may be considered to define an undulating. The end surface 350 is curved so as to define a recessed region 382. It will be appreciated that the recessed region 382 may be formed by angled regions of the end surface, or by any other suitable arrangement. The recessed region 382b of FIG. 8C is defined by a concave curve. The concave curved has a centre point that intersects the axis A. The end surface 350 is substantially symmetrical about the central axis A.

It will be appreciated that the end surface of the nozzle may be provided with any non-linear configuration in order to machine different profiles into a surface of a workpiece, as required. Example of such additional profiles may be semi-circular, hexagonal, oval or elliptical.

Although substantially symmetrical end surfaces have been described with reference to the nozzles of FIGS. 1 to 9C, it will be appreciated that the lower edges may define unsymmetrical profiles in some alternative arrangements.

Although the teachings have been described above with reference to one or more preferred embodiments, it will be appreciated that various changes or modifications may be made without departing from the scope as defined in the appended claims.

1. A nozzle for an electrochemical machining device, the nozzle defining a body comprising:
an internal cavity for receiving an electrolyte therein;
an inlet port upstream of the cavity and in fluid communication therewith for delivering an electrolyte into the cavity; and
an outlet port for dispensing a jet of electrolyte towards a surface of a workpiece, in use,
wherein the outlet port is downstream of the cavity and in fluid communication therewith so as to define a flow path from the inlet port through the cavity to the outlet port, and
wherein the body comprises first and second releasably attachable body portions forming the cavity therebetween, when the first and second body portions are attached.

2. The nozzle according to claim 1, wherein the first and second body portions are configured and arranged to form a seal therebetween surrounding the cavity, when the first and second body portions are attached.

3. The nozzle according to claim 2, wherein the first and second body portions comprise first and second seal formations, respectively, and wherein the first and second seal formations comprise a projection on the first or second body portion and a corresponding recess on the other of the first or second body portion, optionally wherein a sealant is provided in the recess.

4. (canceled)

5. The nozzle according to claim 1, wherein the first and second body portions define first and second opposing cavity walls, respectively, and wherein the first and second opposing cavity walls taper in a direction towards the outlet port.

6. The nozzle according to claim 5, wherein the first and second cavity walls taper to a minimum separation to define a throat portion at a position spaced apart from the outlet port.

7. The nozzle according to claim 6, wherein the first and second opposing cavity walls diverge in a direction between the throat portion and the outlet port such that the separation between the first and second opposing cavity walls increases.

8. The nozzle according to claim 5, wherein the first and second opposing cavity walls each comprise lateral wall portions that define cavity side walls, when the first and second body portions are attached, and wherein the cavity side walls taper in a direction towards the outlet port.

9. (canceled)

10. (canceled)

11. The nozzle according to claim 1, wherein the body comprises an end surface substantially surrounding the outlet port and intended to be arranged to oppose a surface of a workpiece, in use, and wherein said end surface is substantially non-planar.

12. The nozzle according to claim 11, wherein the end surface comprises lateral regions that are at least partially curved or tapered towards an inner region of the end surface.

13. The nozzle according to claim 11, wherein the inner region is curved such that the end surface defines a continuously curved surface or wherein the inner region is substantially planar.

14. (canceled)

15. The nozzle according to claim 11, wherein the inner region is curved or angled such that the inner region forms a recessed region of the end surface.

16. The nozzle according to claim 1, wherein the body comprises an outlet spout surrounding the outlet port, and wherein an external region of the body adjacent to the outlet spout, e.g. above the outlet spout, is tapered or chamfered.

17. The nozzle according to claim 1, comprising an attachment arrangement configured to releasably attach the first and second body portions.

18. The nozzle according to claim 17, wherein the attachment arrangement forms a mounting arrangement for mounting the nozzle to an electrochemical machining device.

19. The nozzle according to claim 1, wherein the outlet port is defined by a spacing between the first and second body portions.

20. (canceled)

21. The nozzle according to claim 1, wherein the body is formed from a conductive material, optionally wherein the body comprises a metal or metal alloy, for example steel.

22. The nozzle according to claim 1, wherein the outlet port comprises a width in the range 1 mm to 25 mm, for example in the range 5 mm to 20 mm, and/or wherein the outlet port comprises a depth in the range 0.01 mm to 1 mm, for example in the range 0.05 mm to 0.5 mm.

23. An electrochemical machining device for machining a surface of a workpiece, the electrochemical machining device comprising:
an electrolyte source; and
a nozzle according to claim 1, the nozzle configured and arranged to receive electrolyte from the electrolyte source via the input port and to dispense an electrolyte jet from the outlet port towards a surface of a workpiece, in use.

24. An electrochemical machining device according to claim 21, wherein the electrochemical machining device is configured to apply a charge to the nozzle and to apply a charge to a surface of a workpiece such that the nozzle and said surface define first and second electrodes of an electrolytic cell, in use, and optionally wherein the nozzle is arranged so as to be spaced apart from a surface of a workpiece, in use.

25. The electrochemical device according to claim 21, comprising a contact electrode configured an arranged to contact a surface of a workpiece, in use, and to apply a current thereto.
